(19) United States
(12) Patent Application Publication
(10) Pub. No.: US 2024/0257058 A1
(43) Pub. Date: Aug. 1, 2024

(54) BUSINESS-TO-BUSINESS SYSTEM FOR PROMOTING AND OPTIMIZING DIVERSITY IN A CLINICAL RESEARCH SETTING

(71) Applicant: RUQAYYAH ABDULRAHOOF, Los Angeles, CA (US)

(72) Inventor: RUQAYYAH ABDULRAHOOF, Los Angeles, CA (US)

(21) Appl. No.: 18/103,208

(22) Filed: Jan. 30, 2023

(51) Int. Cl. G06Q 10/1053

(52) U.S. Cl. CPC G06Q 10/1053

(57) ABSTRACT

A B2B marketplace software system for increasing diversity among the clinical research and development workforce and trust within diverse communities resulting in diverse clinical trials is disclosed. The B2B marketplace software system is configured to connect biotechnology/biopharmaceutical/medical device/health tech and other relevant companies with a pool of qualified clinical research suppliers; connect a diverse pool of qualified talent with biotechnology/biopharmaceutical/medical device/health tech and other relevant companies; cut talent recruitment and supplier discovery costs for biotechnology/biopharmaceutical/medical device/health tech and other relevant companies; and connect industry suppliers with more opportunities.

### BACKGROUND

### Technical Field

The present disclosure relates, in general, to business-to-business software, and, more particularly, but without limitation, to business-to-business online software utilized to engage in exchanges between professionals and organizations in the healthcare, medical, clinical research and/or health technology spaces.

Software systems for evaluating corporate responsibility and cultural well-being is known in the art.

US 2006/0100897 discloses a system for assessing and improving social responsibility of a business.

WO 2021/142119 discloses a cultural wellbeing index.

CA 2,595,830 discloses a smart communications system for integration into a workflow-engaged clinical environment.

However, none of the art provides the lack of diversity in clinical research and development and creating trust in communities. There is a need for a business-to-business (“B2B”) method of hiring diverse Service Providers (“Suppliers”) and professionals (e.g., candidates, talent) in a clinical research setting in order to improve trust among diverse populations.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclosure, a system to connect agents in a medical/clinical technology business-to-business marketplace is disclosed. The system includes at least one memory configured to store computer executable instructions; and at least one processor configured to execute the computer executable instructions to: receive first qualifying information from a first agent in the medical/clinical technology business-to-business marketplace; receive second qualifying information from a second agent in the medical/clinical technology business-to-business marketplace; determine a qualifying agent selected from one of the first agent or the second agent by filtering the first qualifying information and/or second qualifying information; and connect the qualifying agent with one of the first agent or the second agent.

In an aspect of the disclosure, a method for connecting agents in a medical/clinical technology business-to-business marketplace is disclosed. The method includes receiving first qualifying information from a first agent in the medical/clinical technology business-to-business marketplace; receiving second qualifying information from a second agent in the medical/clinical technology business-to-business marketplace; determining a qualifying agent selected from one of the first agent or the second agent by filtering the first qualifying information and/or second qualifying information; and connecting the qualifying agent with one of the first agent or the second agent.

In an aspect of the disclosure, a non-transitory computer readable medium is disclosed. The computer program product includes computer executable instructions stored thereon, which when executed by one or more processors, cause the one or more processors to connect agents in a medical/clinical technology business-to-business marketplace. The computer program product includes computer executable instructions to: receive first qualifying information from a first agent in the medical/clinical technology business-to-business marketplace; receive second qualifying information from a second agent in the medical/clinical technology business-to-business marketplace; determine a qualifying agent selected from one of the first agent or the second agent by filtering the first qualifying information and/or second qualifying information; and connect the qualifying agent with one of the first agent or the second agent.

The foregoing summary is illustrative only and is not intended to be in any way limiting. In addition to the illustrative aspects and features described above, further aspects and features will become apparent by reference to the drawings and the following detailed description

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows components of one aspect of a computing environment for connecting agents in a medical/clinical technology business-to-business marketplace;

FIG. 2 shows one aspect of a client computer for connecting agents in a medical/clinical technology business-to-business marketplace.

FIG. 3 shows one aspect of a network computer that may at least partially implement one of the various aspects for connecting agents in a medical/clinical technology business-to-business marketplace;

FIG. 4 illustrates an exemplary block diagram of a system for connecting agents in a medical/clinical technology business-to-business marketplace; and

FIG. 5 illustrates a flowchart for acts taken in an exemplary method for connecting agents in a medical/clinical technology business-to-business marketplace.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well known features have not been described so as not to obscure the disclosure. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

Currently, there is a lack of diversity in clinical research & development. For example, ethnic minorities and females experience higher rates of certain physical and mental illnesses but are typically under-represented in clinical studies. For cancer, African American (AA)/Black women (BW) have a higher rate of mortality, dying 41% more than white women from the same breast cancer diagnosis. However, BW represented only 3% of clinical trial participants for breast cancer drugs approved from 2008-2018. For infectious diseases, AA and Black people are 1.5 times more likely to get COVID-19. Latinx people are twice as likely to get COVID-19. People of color were underrepresented in late-stage COVID vaccine trials compared to their share of the population. Additionally, for dementia, AA/Black people are two times more likely than white people to develop Alzheimer's disease (AD) yet represent only 2% of those in clinical trials. Hispanics are about one and one-half times more likely than whites to have AD and other dementias.

Despite people of color being more likely to contract COVID-19, become hospitalized and die, communities of color resisted receiving the COVID-19 vaccination. The United States government and nations alike attempted to build trust among communities during the plight of COVID-19 but resistance persisted. Subtly addressing healthcare mistrust among people of color during a pandemic is not enough to sustain diversity and inclusion in clinical research and development.

Biopharmaceutical, Biotechnology, Medical device and other companies alike, lack diverse employment practices and minority representation within their companies. For example, 12% of Biopharmaceutical and Biotechnology companies within a certain region employ no people of color. More importantly, Executive and board level positions within these companies do not reflect the populations in which these companies are marketing and/or selling products to. Therefore, the clinical decision making, impacting the masses, comes into public questioning.

The clinical research & development conducted by these companies are still perceived in the same light as the Tuskegee Syphilis experiment—white researchers experimenting on people of color whilst violating bioethical principles of respect for autonomy. This perception among certain populations will continue until the inside of organizations and engaged Suppliers reflect the necessary diversity within clinical research & development. Diversifying marketing materials will never be enough and does not address the root cause.

Lack of diversity in research persists because of a vicious product development lifecycle and governmental difficulty in holding Sponsors (e.g., Biopharmaceutical and Biotechnology companies) accountable for research diversity while also putting the public first: (1) Sponsors conduct research within a non-diverse population submitting applications for marketing authorization, (2) Health authorities (HA) (e.g., Food and Drug Administration, Health Canada, European Medicines Agency) push back questioning generalizability of study data due to lack of diversity among study participants, (3) Sponsors respond to HA concerns promising to pursue diversity in future research initiatives pleading for approval for patients who need options now, and finally, (4) The HA approves the Sponsor's product in efforts to meet the needs of the public. Then, the cycle repeats.

Another problem relates to delayed research initiatives due to difficulty finding talent and relevant Suppliers. Big, medium-sized, and small Biopharmaceutical and Biotechnology companies contract external recruiting firms to discover talent in various departments (e.g., clinical affairs, medical affairs, regulatory affairs). Many of these vendors resort to spamming techniques which results in people thinking many jobs in clinical research are a “scam.”

The current talent pool within clinical research is limited. There are more jobs than there is talent to fill them. Limited talent makes it a challenge for Sponsors to execute research initiatives and efficiently provide treatment options for patients. Diverse and qualified talent (e.g., BS, MPH, RN's, PharmD's) are also unaware of opportunities within clinical research due to limited knowledge about the industry and/or skepticism.

Sponsors often use Contract Research Organizations (CROs) and/or consulting firms to execute various research tasks (e.g., data management, trial monitoring, regulatory affairs consulting, pharmacovigilance). The smaller the organization the more dependence there is on such Suppliers. Sponsors spend months searching for and qualifying suppliers to support their research. Suppliers with relevant therapeutic experience is essential. Removing the time to discover qualified suppliers would expedite research initiatives tremendously.

Therefore, a need exists for a B2B software platform to increase diversity among the clinical research workforce and trust within diverse communities. In an aspect of the disclosure, the B2B software platform connects Biopharmaceutical and Biotechnology companies with a pool of qualified clinical research suppliers. In another aspect, the B2B software platform connects a diverse pool of qualified talent/professionals with Biopharmaceutical and Biotechnology companies. In another aspect, the B2B software platform cuts costs for talent recruitment and supplier discovery for Biopharmaceutical and Biotechnology companies. In another aspect, the B2B software platform connects suppliers with more opportunities.

According to some aspects, the presently disclosed B2B system and/or method will allow users to discover diverse suppliers, by filtering by therapeutic relevance, by filtering by supplier type (e.g., regulatory consulting, CROs, etc.), and allow sponsors to submit inquires and a supplier to provide a response utilizing inboxes implemented by the B2B software platform.

According to some aspects of the disclosure, the presently disclosed B2B system and/or method allows users to discover diverse talent by viewing talent profiles, filtering by education, filtering by years of experience, communicating with talent and scheduling interviews utilizing inboxes implemented by the B2B software platform.

In an aspect of the disclosure, a system to connect agents in a medical/clinical technology business-to-business marketplace is disclosed. The system is configured to receive first qualifying information from a first agent in the medical/clinical technology business-to-business marketplace; receive second qualifying information from a second agent in the medical/clinical technology business-to-business marketplace; determine a qualifying agent selected from one of the first agent or the second agent by filtering the first qualifying information and/or second qualifying information; and connect the qualifying agent with one of the first agent or the second agent.

In an aspect of the disclosed B2B system, an agent may be a medical/clinical technology research company in the B2B marketplace, a medical/clinical technology supplier in the B2B marketplace or a medical/clinical technology employee candidate. It is understood that “medical technology” may be biotechnology (“biotech”), biopharmaceutical technology (“biopharma”), medical/clinical instrument technology, medical/clinical electronics technology, medical/clinical detection equipment or other medical/clinical technology that typically utilizes clinical research and technology to develop and promote products and/or services related to the medical/clinical technology B2B marketplace.

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

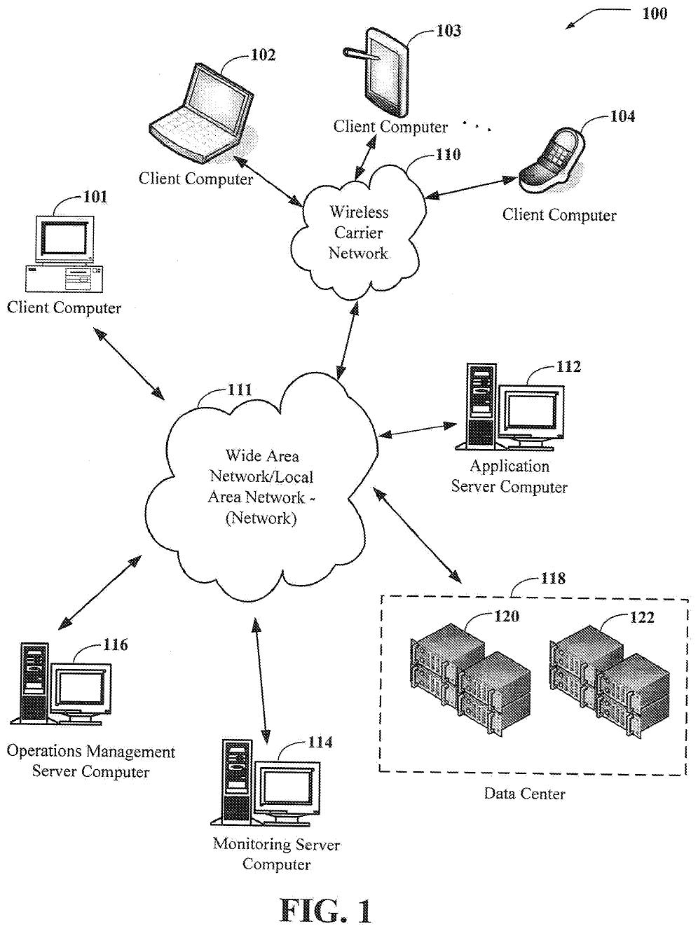

FIG. 1 shows components of one aspect of a computing environment 100 for connecting agents in a medical/clinical technology business-to-business marketplace. Not all the components may be required to practice various aspects, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement the disclosed medical/clinical technology B2B marketplace.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IoT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one aspect, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one aspect, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other aspects. Further, it should be recognized that more or less client computers may be included within a system such as described herein, and aspects are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one aspect, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. In essence, the network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

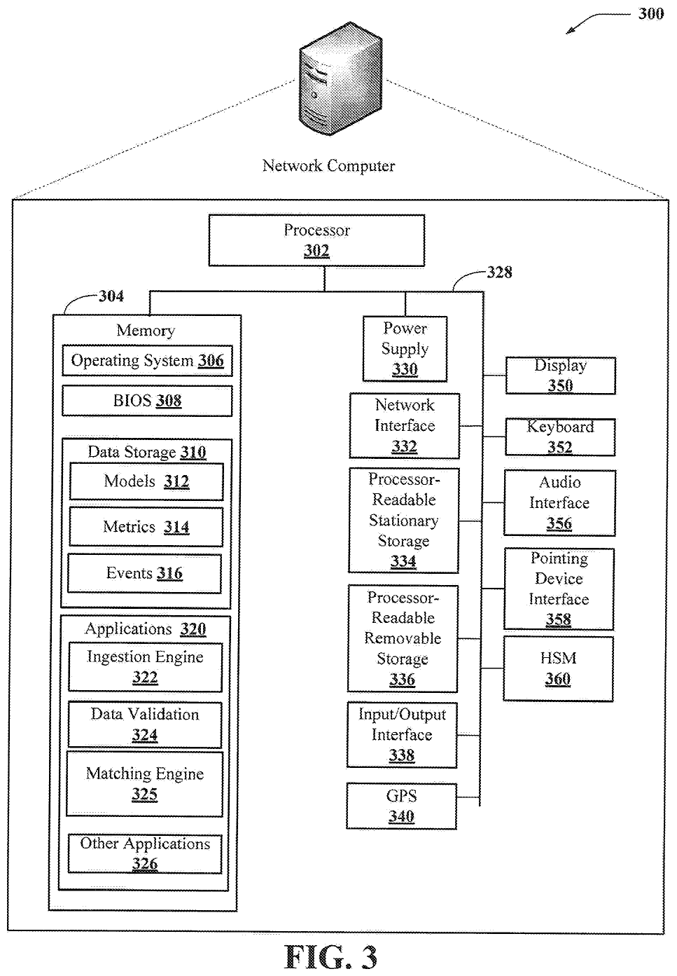

The operations management server computer 116 may include virtually any network computer usable to provide computer operations management services, such as a network computer, as described with respect to FIG. 3. In one aspect, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various aspects, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some aspects, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the disclosure is not so limited. Thus, the operations management server computer 116 may represent a plurality of network computers. For example, in one aspect, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some aspects, one or more data centers, such as a data center 118, may be communicatively coupled to the wireless network 110 and/or the network 111. In at least one of the various aspects, the data center 118 may be a portion of a private data center, public data center, public cloud environment, or private cloud environment. In some aspects, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some aspects, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various aspects, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

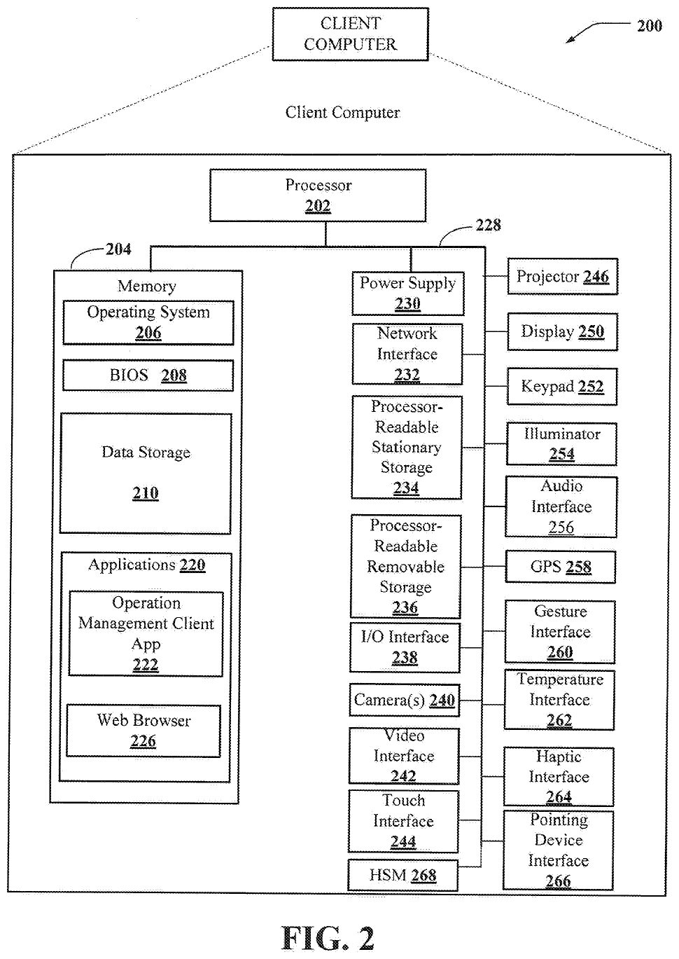

FIG. 2 shows one aspect of a client computer 200. The client computer 200 may include more or less components than those shown in FIG. 2. The client computer 200 may represent, for example, at least one aspect of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one aspect, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one aspect, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one aspect, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various aspects, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more aspects (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the client computer 200 may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one aspect of network computer 300 that may at least partially implement one of the various aspects. The network computer 300 may include more or fewer components than those shown in FIG. 3. The network computer 300 may represent, for example, one aspect of at least one medical technology B2B marketplace system according to the disclosure, such as the operations management server computer 116 of FIG. 1, the monitoring server computer 114 of FIG. 1, or an application server computer 112 of FIG. 1. Further, in some aspects, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one aspect, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one aspect, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may include an ingestion engine 322, a data validation engine 324, matching engine 325, or other applications 327. In at least one of the various aspects, one or more of the applications may be implemented as modules or components of another application. Further, in at least one of the various aspects, applications may be implemented as operating system extensions, modules, plugins, or the like.

Furthermore, in at least one of the various aspects, the ingestion engine 322 for receiving agent information related to the disclosed medical technology B2B marketplace, the data validation engine 324 for confirming data integrity and applicability for processing by the system, the matching engine 325 for determining matches between agents in the medical technology B2B marketplace, and/or other applications 326, or the like, may be operative in a cloud-based computing environment. In at least one of the various aspects, these applications, and others, that comprise the management platform may be executing within virtual machines or virtual servers that may be managed in a cloud-based based computing environment. In at least one of the various aspects, in this context the applications may flow from one physical network computer within the cloud-based environment to another depending on performance and scaling considerations automatically managed by the cloud computing environment. Likewise, in at least one of the various aspects, virtual machines or virtual servers dedicated to the ingestion engine 322, the data validation engine 324, the matching engine 325, and/or the other applications 326, may be provisioned and de-commissioned automatically.

In at least one of the various aspects, the applications may be arranged to employ geo-location information to select one or more localization features, such as, time zones, languages, currencies, calendar formatting, or the like. Localization features may be used in user-interfaces and well as internal processes or databases. Further, in some aspects, localization features may include information regarding culturally significant events or customs which may provide a source of audio compositions for evaluation (e.g., concerts, performances, local holidays, political events, or the like). In at least one of the various aspects, geo-location information used for selecting localization information may be provided by the GPS transceiver 340. Also, in some aspects, geolocation information may include information providing using one or more geolocation protocol over the networks, such as, the wireless network 108 or the network 111.

Also, in at least one of the various aspects, the ingestion engine 322, the data validation engine 324, the matching engine 325, and/or the other applications 326, or the like, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 360 may be a stand-alone network computer, in other cases, the HSM 360 may be arranged as a hardware card that may be installed in a network computer.

Additionally, in one or more aspects (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the network computer may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

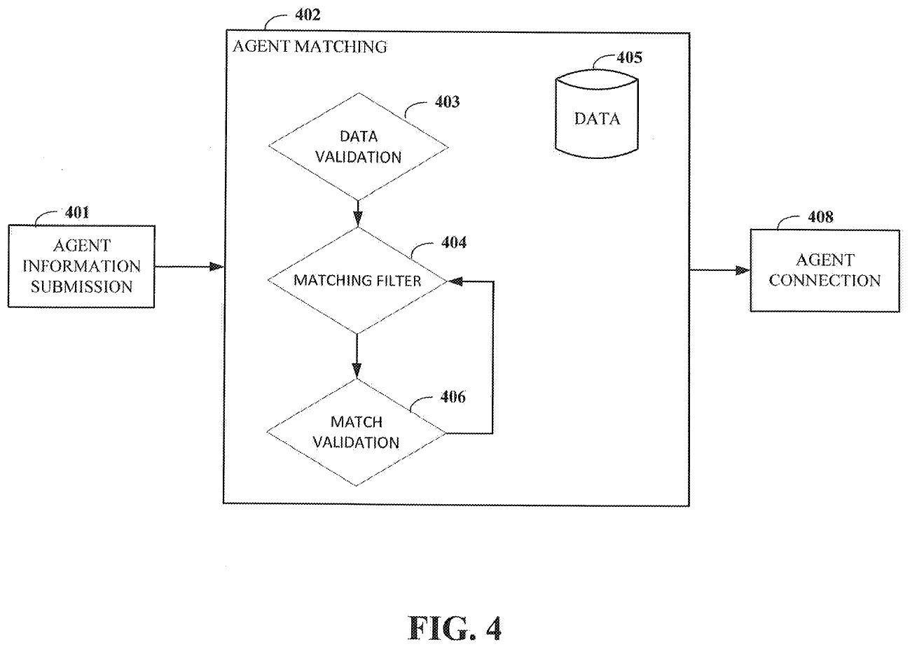

FIG. 4 illustrates an exemplary block diagram of a system for connecting agents in a medical technology B2B marketplace, according to an aspect of the disclosure. The system includes an agent information input system or ingestion engine 401, where an agent's qualifying information that the agent wishes to search against, is provided to the system. As described herein, an agent is a person or entity in the medical technology field, such as, in an aspect, clinical testing for medical products and/or services, who wishes to use the disclosed medical technology B2B system to connect with other agents in the B2B marketplace, to find qualified medical technology research companies, medical technology suppliers or medical technology employee candidates. An agent may be one of several agents in B2B marketplace, such as a first agent, a second agent or more. An agent may enter, into the ingestion engine 401, qualifying information such as a medical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance, etc. The agent qualifying information is transferred to the agent matching engine 402 for further processing and output of a match between a first agent and at least a second agent or other agents. At data validation engine 403, the system processes the agent qualifying information to confirm data quality, conformity with standards for input and processing, applicability of the agent's qualifying information for processing in the disclosed medical technology B2B marketplace system or other data validation steps needed for further processing by the system 403, the system may select sampling/resampling options for processing the audio, either through pre-selected options or user-selected options.

A matching filter engine 404 may be used to determine a qualifying agent selected from one of the first agent or the second agent by filtering the first qualifying information of the first agent and/or the second qualifying information from the second agent. The matching filter engine 404 may compare subsets of the qualifying information or the entire set of qualifying information from the agents in the system. In an aspect, the matching filter engine 404 may match medical technology company with a qualifying medical technology employee candidate and/or to match the medical technology company with a qualifying medical technology supplier. The medical technology company may seek out medical technology suppliers that satisfy certain qualifying information requirements, such as the therapeutic relevance of the supplier, supplier type (i.e., regulatory consulting, CROs, etc.), reputation, diversity measures or diversity information about the medical technology supplier, etc. The medical technology company may seek out talent for open employment positions within the medical technology company, by evaluating qualifying information of the medical technology employee candidate, such as geographic location, education level, experience level and type of experience, demographic and diversity information, previous company information, etc. Likewise, the matching filter engine 404 may allow a medical technology employee candidate to evaluate medical technology companies using similar qualifying information, such as open employment or internship opportunities, education level and experience associated with open opportunities within the company, geographic information, diversity information about the medical technology company, reputation, corporate governance information, social, ethical and environmental responsibility, etc.

The matching filter engine 404 may determine a qualifying agent from the at least first agent and second agent by matching the qualifying candidate with the first agent or the second agent based on a highest match level of the first qualifying information and the second qualifying information. The matching filter engine 404 may apply a weighting to certain qualifying information based on agent input, past agent selections or actions within the system, weights derived from modeling data in the system or modeled as a machine learning model to predict a qualifying agent based on qualifying information supplied by agents or other data samples.

A database 405 may be operatively connected to the agent mapping engine 402. The database 405 may be contained within the agent mapping engine 402, located remotely from the agent mapping engine 402 or may be a distributed database across a network and connected devices. The database 405 may store agent qualifying information, software code for the matching filter engine 404 and other engines within the agent mapping engine 402.

The agent mapping engine 402 may include a match validation engine 406. The match validation engine 406 may confirm the quality of the match between an agent and a corresponding qualifying agent. The match validation engine 406 may examine whether the qualifying agent is still available in the database 405, whether match is the highest match based on previous operations by the agent mapping engine 402, or other output quality determinations.

Once a match is determined for a qualifying agent to a first agent, second agent, or more agents, the system will employ an agent connection engine 408. The agent connection engine 408 may connect an agent with its corresponding qualifying agent(s) to facilitate communication between the agents. In an aspect, the agent connection engine 408 may provide a query inbox for the qualifying agent and the one of the first agent or the second agent to exchange information and/or queries related to the medical technology business-to-business marketplace. In an aspect, the query inbox could be an email inbox on an email server, web template for an agent to fill in to connect with a qualifying agent, a video “mailbox”, an SMS or other text message interface that allows agents to connect, or other mechanisms known to one of skill in the art to facilitation connection between agents in the medical technology B2B marketplace.

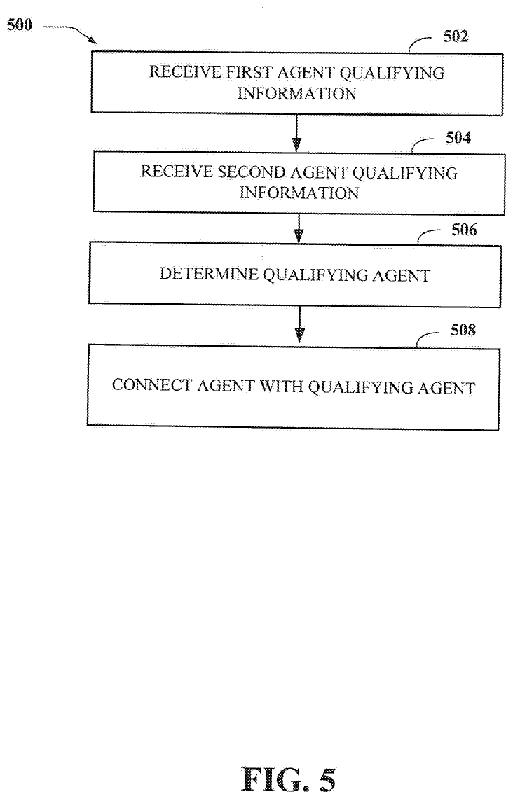

FIG. 5 illustrates a flowchart 500 for acts taken in an exemplary method for connecting agents in a medical technology B2B marketplace. FIG. 5 is explained in conjunction with FIG. 1 to FIG. 4. The control starts at act 502.

At act 502, the system receives and/or ingests receive first qualifying information from a first agent. The first agent may be a medical technology research company or a prospective medical technology employee candidate. The first agent qualifying information may be a medical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance or a combination thereof.

At act 504, the system receives and/or ingests receive second qualifying information from a second agent. The second agent may be a medical technology research company, a medical technology supplier or a medical technology employee candidate. The second agent qualifying information may be a medical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance or a combination thereof.

At act 506, the system may determine a qualifying agent selected from one of the first agent or the second agent by filtering the first qualifying information and/or second qualifying information. In an aspect, the system may determine the qualifying agent by matching the medical technology company with a qualifying medical technology employee candidate and/or by match the medical technology company with a qualifying medical technology supplier.

In an aspect, disclosed medical technology B2B marketplace software platform may match medical technology company with a qualifying medical technology employee candidate and/or to match the medical technology company with a qualifying medical technology supplier. The medical technology company may seek out medical technology suppliers that satisfy certain qualifying information requirements, such as the therapeutic relevance of the supplier, supplier type (i.e., regulatory consulting, CROs, etc.), reputation, diversity measures or diversity information about the medical technology supplier, etc. The medical technology company may seek out talent for open employment positions within the medical technology company, by evaluating qualifying information of the medical technology employee candidate, such as geographic location, education level, experience level and type of experience, demographic and diversity information, previous company information, etc.

In an aspect, the system may determine the qualifying agent by matching a medical technology employee candidate with prospective medical technology companies that the medical technology employee candidate finds attractive based on the qualifying information of the medical technology company. In an aspect, and as described herein, the disclosed B2B marketplace software platform may allow a medical technology employee candidate to evaluate medical technology companies using similar qualifying information, such as open employment or internship opportunities, education level and experience associated with open opportunities within the company, geographic information, diversity information about the medical technology company, reputation, corporate governance information, social, ethical and environmental responsibility, etc.

In an aspect, the system may determine a qualifying agent from the at least first agent and second agent by matching the qualifying candidate with the first agent or the second agent based on a highest match level of the first qualifying information and the second qualifying information. The matching filter engine 404 may apply a weighting to certain qualifying information based on agent input, past agent selections or actions within the system, weights derived from modeling data in the system or modeled as a machine learning model to predict a qualifying agent based on qualifying information supplied by agents or other data samples.

At act 508, the system connects the qualifying agent with the agent that matches with the qualifying agent based on qualifying information provided by the agent and agent preferences. The system may connect an agent with its corresponding qualifying agent(s) to facilitate communication between the agents. In an aspect, the system may provide a query inbox for the qualifying agent and the one of the first agent or the second agent to exchange information and/or queries related to the medical technology business-to-business marketplace. In an aspect, the query inbox could be an email inbox on an email server, web template for an agent to fill in to connect with a qualifying agent, a video “mailbox”, an SMS or other text message interface that allows agents to connect, or other mechanisms known to one of skill in the art to facilitation connection between agents in the medical technology B2B marketplace.

Users of the disclosed system, such as the agents described herein, would utilize the B2B marketplace to increase diversity among the clinical research & development workforce and trust within diverse communities, resulting to diverse clinical trials, by connecting with medical technology companies, medical technology suppliers and medical technology employee candidates using the software. Connecting among all three users would cut talent and supplier recruitment costs for medical technology companies and medical supplier companies and increase the awareness of opportunities in clinical research among diverse talent. Connection among all three users would improve community awareness and greater visibility into clinical research initiatives resulting in a greater trust in the research being performed.

Blocks of the flowchart 500 support combinations of means for performing the specified functions and combinations of operations for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system to connect agents in a medical/clinical technology business-to-business marketplace, the system comprising:
at least one memory configured to store computer executable instructions; and
at least one processor configured to execute the computer executable instructions to:
receive first qualifying information from a first agent in the medical/clinical technology business-to-business marketplace;
receive second qualifying information from a second agent in the medical/clinical technology business-to-business marketplace;
determine a qualifying agent selected from one of the first agent or the second agent by filtering the first qualifying information and/or second qualifying information; and
connect the qualifying agent with one of the first agent or the second agent.

2. The system of claim 1, where the first qualifying information and/or the second qualifying information comprises a medical/clinical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance or a combination thereof.

3. The system of claim 1, where the first agent comprises a medical/clinical technology research company or a prospective medical/clinical technology employee candidate.

4. The system of claim 3, where the second agent comprises a medical/clinical technology research company, a medical technology supplier or a medical/clinical technology employee candidate.

5. The system of claim 4, where the computer executable instructions to determine the qualifying agent comprise computer executable instructions to match the medical/clinical technology company with a qualifying medical/clinical technology employee candidate and/or to match the medical/clinical technology company with a qualifying medical/clinical technology supplier.

6. The system of claim 1, where the computer executable instructions to determine the qualifying agent comprise the computer executable instructions to match the qualifying candidate with the first agent or the second agent based on a highest match level of the first qualifying information and the second qualifying information.

7. The system of claim 1, where the computer executable instructions to connect the qualifying agent with one of the first agent or the second agent comprise the computer executable instructions to provide a query inbox for the qualifying agent and the one of the first agent or the second agent to exchange information and/or queries related to the medical/clinical technology business-to-business marketplace.

8. A method to connect agents in a medical/clinical technology business-to-business marketplace, the method comprising:
receiving first qualifying information from a first agent in the medical/clinical technology business-to-business marketplace;
receiving second qualifying information from a second agent in the medical/clinical technology business-to-business marketplace;
determining a qualifying agent selected from one of the first agent or the second agent by filtering the first qualifying information and/or second qualifying information; and
connecting the qualifying agent with one of the first agent or the second agent.

9. The method of claim 8, where the first qualifying information and/or the second qualifying information comprises a medical/clinical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance or a combination thereof.

10. The method of claim 8, where the first agent comprises a medical/clinical technology research company or a prospective medical/clinical technology employee candidate.

11. The method of claim 10, where the second agent comprises a medical/clinical technology research company, a medical/clinical technology supplier or a medical/clinical technology employee candidate.

12. The method of claim 11, where determining the qualifying agent comprises matching the medical/clinical technology company with a qualifying medical/clinical technology employee candidate and/or matching the medical/clinical technology company with a qualifying medical/clinical technology supplier.

13. The method of claim 8, where determining the qualifying agent comprises matching the qualifying candidate with the first agent or the second agent based on a highest match level of the first qualifying information and the second qualifying information.

14. The method of claim 8, where connecting the qualifying agent with one of the first agent or the second agent comprises providing a query inbox for the qualifying agent and the one of the first agent or the second agent to exchange information and/or queries related to the medical/clinical technology business-to-business marketplace.

15. A computer program product comprising a non-transitory computer readable medium having stored thereon computer executable instructions, which when executed by one or more processors, cause the one or more processors to connect agents in a medical/clinical technology business-to-business marketplace, the operations comprising:
receiving first qualifying information from a first agent in the medical/clinical technology business-to-business marketplace;
receiving second qualifying information from a second agent in the medical/clinical technology business-to-business marketplace;
determining a qualifying agent selected from one of the first agent or the second agent by filtering the first qualifying information and/or second qualifying information; and
connecting the qualifying agent with one of the first agent or the second agent.

16. The computer program product of claim 14, where the first qualifying information and/or the second qualifying information comprises a medical/clinical technology area, an employment opportunity, an employment opportunity experience level, an employment opportunity education level, an employee candidate education level, an employee candidate experience level, geographic information for the first agent and/or the second agent, diversity information about the first agent and/or the second agent, a supplier technology field, a supplier type, a supplier therapeutic relevance or a combination thereof.

17. The computer program product of claim 14, where the first agent comprises a medical/clinical technology research company or a prospective medical/clinical technology employee candidate.

18. The computer program product of claim 16, where the second agent comprises a medical/clinical technology research company, a medical/clinical technology supplier or a medical/clinical technology employee candidate.

19. The computer program product of claim 17, where the computer executable instructions to determine the qualifying agent comprise computer executable instructions to match the medical/clinical technology company with a qualifying medical/clinical technology employee candidate and/or to match the medical/clinical technology company with a qualifying medical/clinical technology supplier.

20. The computer program product of claim 15, where the computer executable instructions to determine the qualifying agent comprise computer executable instructions to match the qualifying candidate with the first agent or the second agent based on a highest match level of the first qualifying information and the second qualifying information.

21. The computer program product of claim 15, where the computer executable instructions to connect the qualifying agent with one of the first agent or the second agent comprise computer executable instructions to provide a query inbox for the qualifying agent and the one of the first agent or the second agent to exchange information and/or queries related to the medical/clinical technology business-to-business marketplace.
